(19) United States
(12) Patent Application Publication
(10) Pub. No.: US 2025/0236058 A1
(43) Pub. Date: Jul. 24, 2025

(54) METHOD FOR PRODUCING INSULATING ELEMENTS

(71) Applicant: SIKA TECHNOLOGY AG, Baar (CH)

(72) Inventors: Nuno ROSINHA, Widen (CH); Marcel MEISTER, Hochfelden (CH)

(73) Assignee: SIKA TECHNOLOGY AG, Baar (CH)

(21) Appl. No.: 18/699,659

(22) PCT Filed: Nov. 22, 2022
(86) PCT No.: PCT/EP2022/082710

§ 371 Date: Apr. 9, 2024

(30) Foreign Application Priority Data
Nov. 29, 2021 (EP) 21211093.6

(51) Int. Cl. B29C 48/12; B29C 48/00; B29C 48/16; B29L 31/00; B29L 31/30

(52) U.S. Cl. CPC B29C 48/12; B29C 48/0012; B29C 48/0022; B29C 48/16; B29L 2031/003; B29L 2031/30

(57) ABSTRACT

A method for producing an insulating element for insulating a structural element in a motor vehicle includes the steps of: extruding a carrier and an expandable material; trimming the extrudate; and removing constituents of the carrier and/or of the expandable material from the trimmed extrudates in order to form individual insulating elements.

The invention relates to a method for producing insulating elements for insulating a structural element in a motor vehicle.

In many cases, components such as, for example, vehicle bodies and/or frames of means of transport and locomotion, in particular of water or land vehicles or of aircraft, have structures with cavities in order to allow lightweight designs. However, these cavities cause a wide variety of problems. Depending on the type of the cavity, the latter has to be sealed in order to prevent the ingress of moisture and dirt, which may lead to corrosion of the components. It is often also desirable to substantially reinforce the cavities and therefore the component, but to maintain the low weight. It is often also necessary to stabilize the cavities and therefore the components, in order to reduce noise which would otherwise be transmitted along or through the cavity. Many of these cavities have an irregular shape or a narrow extent, which makes it more difficult to seal, reinforce and insulate them properly.

Particularly in automotive construction, but also in aircraft construction and boatbuilding, sealing elements (baffles) are therefore used in order to seal and/or acoustically isolate cavities, or reinforcing elements (reinforcers) are used in order to reinforce cavities.

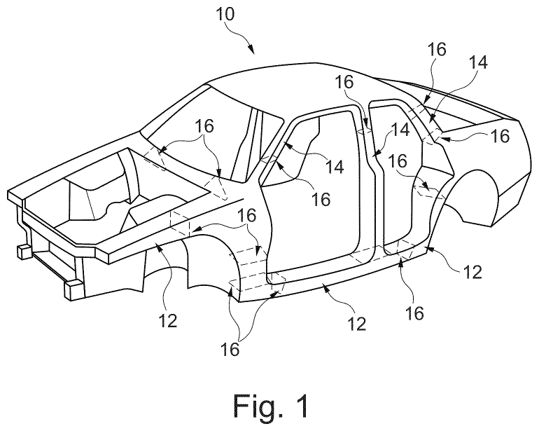

FIG. 1 shows schematically a vehicle body of an automobile. The vehicle body 10 here has various structures with cavities, for example pillars 14 and carriers or struts 12. Such structural elements 12, 14 with cavities are usually sealed or reinforced with sealing and/or reinforcing elements 16.

A disadvantage of the previously known sealing and/or reinforcing elements is that an individually adapted element has to be produced for each vehicle body shape and for each cavity of a vehicle body. This results in high development and production costs and is disadvantageous in particular in the case of relatively small vehicle series.

It is therefore an object of the present invention to provide an improved insulating element for insulating a structural element in a motor vehicle, which avoids the disadvantages of the prior art. The insulating element is intended to provide in particular economic advantages in the case of small series and to reduce the development and production outlay of the insulating elements overall.

This object is achieved by a method for producing an insulating element for insulating a structural element in a motor vehicle, the method comprising the steps of: extruding a carrier and an expandable material in an extrusion direction, a cross section of the extrudate having a substantially rectangular basic shape perpendicularly to the extrusion direction, a largest width of the extrudate being at most 20% more than a smallest width of the extrudate, and a largest height of the extrudate being at most 20% more than a smallest height of the extrudate; trimming the extrudate; and removing constituents of the carrier and/or of the expandable material from the trimmed extrudates in order to form individual insulating elements. Trimming means trimming cutting the extrudate to length.

This solution has the advantage that different types of insulating elements may be produced by such a production method without having to incur high costs for production tools.

It is, in particular, a central concept of the present invention that differently shaped insulating elements may be produced by removing constituents of the carrier and/or of the expandable material from the trimmed extrudates, without having to modify the extrusion device or the production tools. By the subsequent shaping of the trimmed extrudates, insulating elements, which are originally obtained from the same extrudate with the same cross section, may therefore be formed which are adapted for different applications. In particular, this offers cost advantages for small series or for prototypes, for which it is often not profitable to invest in separate tools.

Furthermore, development costs may also be saved in many cases by the method proposed here because the method is very variable and adaptable owing to the subsequent step of shaping by removal. First insulating elements may therefore initially be produced and tested, and the insulating elements may be improved or adapted in a successive method.

By a substantially rectangular cross section of the extrudate being provided, downstream shaping of the trimmed extrudates to form many different types may be carried out. Because the cross section is constructed continuously both over its width and over its height, the basic property of the insulating element is preserved by downstream removal. The insulating element may therefore be adapted in its size without losing the intended properties in respect of the insulation.

In the context of this invention, the term “insulating element” or “insulation” or “insulated” refers to elements or structures or method steps for isolating and/or closing and/or reinforcing and/or insulating a structural element. These various characteristics of such an insulating element may occur individually or in combination with one another.

In one exemplary embodiment, the extrudate is cut substantially perpendicularly to the extrusion direction during the trimming.

In an alternative embodiment, the extrudate is cut obliquely with respect to the extrusion direction or in the shape of an arc or wave or in a zigzag line during the trimming.

In one exemplary embodiment, the carrier is extruded with a first wall and a second wall, which extend substantially parallel to one another and are connected to one another by at least one rib.

In a first development, the expandable material is extruded between the two walls.

In a second exemplary development, the expandable material is extruded onto outer sides of the walls, a region between the walls remaining free from expandable material.

Depending on which functions of the insulating element are weighted more strongly, the expandable material may be arranged in different ways on the carrier. For example, it is suitable to arrange the expandable material between two walls, particularly in order to form insulating elements which are primarily used to isolate and/or close a structural element.

Arranging the expandable material on the outer sides of the two walls extending parallel is suitable in particular for insulating elements which are primarily intended to be used for reinforcing a structural element.

In one exemplary embodiment, the carrier is furthermore extruded with protective walls, which are arranged on the outer side of the two walls and next to the expandable material.

Providing such protective walls offers the advantage that mechanical protection of the expandable material may thereby be ensured. This is advantageous in particular for transport and handling of the insulating elements.

In one exemplary embodiment, a plurality of ribs are extruded between the two walls so as to form a mechanically load-bearing carrier.

In one exemplary embodiment, the carrier is extruded as a plate (also called sheet), the expandable material being extruded on one or both sides of the plate.

In one exemplary embodiment, at least one clip, which protrudes beyond the rectangular basic shape of the cross section of the extrudate, is extruded integrally with the carrier. Extruded integrally means being extruded in one piece with the carrier.

In one exemplary embodiment, a depth of the clip is reduced in the extrusion direction during the removal to such an extent that one or more clips having a depth of less than 1 cm, in particular less than 0.6 cm, are thereby formed.

One-piece extrusion and subsequent shaping of clips together with the carrier material has the advantage that downstream steps for finishing the insulating elements are no longer necessary.

In one alternative embodiment, the method comprises the additional steps: forming at least one opening in the extruded carrier; and introducing a prefabricated clip into the opening.

In one exemplary embodiment, the prefabricated clip is formed from a different material than the extruded carrier.

The use of different materials for the clip and the carrier offers the advantage that the materials for the respective constituents may thereby be optimized. For example, a stiffer material may be advantageous for using the carrier and a softer, more flexible material may be advantageous for forming the clip.

In one exemplary embodiment, a rectangular basic outline of the trimmed extrudates, which lies in a plane of the extrusion direction and of the width of the extrudate, is modified into a non-rectangular shape during the removal.

In one exemplary embodiment, in particular, a width of the cross section of the extrudate is reduced during the removal.

In one exemplary embodiment, in particular, an edge of the rectangular basic outline of the trimmed extrudates is brought into an irregularly shaped line during the removal.

In one exemplary embodiment, at least one film is integrated during the extrusion in such a way that the at least one film connects the first wall and the second wall of the carrier to one another.

Providing such a film has the advantage that deformation of the insulating element during an expansion of the expandable material may be prevented by the film holding the two walls together.

In one exemplary development, the film is a metal film or a plastic film.

In one exemplary development, the film has a thickness of less than 0.8 mm, in particular less than 0.5 mm, in particular less than 0.3 mm.

In one exemplary development, the film is anchored both in the first wall and in the second wall.

In one exemplary development, at least two or at least three films are integrated during the extrusion.

In one exemplary embodiment, projections which are arranged on the carrier and which protrude into the expandable material are formed during the extrusion.

Such projections offer the advantage that delamination of the expandable material may be prevented during and/or after an expansion by the binding of the expanding or expanded material to the carrier being improved.

In one exemplary development, the projections are formed from the same material as the carrier, and/or the projections are formed in one piece with the carrier.

In one exemplary development, the projections protrude by between 2 and 20 mm, in particular between 3 and 15 mm, in particular between 4 and 12 mm from a carrier structure, in particular walls or plates of the carrier, into the expandable material.

In one exemplary development, the insulating element has at least two or at least three or at least four or at least five or at least six such projections.

In one exemplary development, the projections are arranged substantially perpendicularly to a plate and/or a wall of the carrier.

In principle, various materials which can be foamed may be used as the expandable material. The material may or may not have reinforcing properties. Typically, the expandable material is expanded thermally, by moisture or by electromagnetic radiation.

Such an expandable material typically has a chemical or a physical blowing agent. Chemical blowing agents are organic or inorganic compounds which decompose under the effect of temperature, moisture or electromagnetic radiation, at least one of the breakdown products being a gas. Physical blowing agents used may, for example, be compounds that are converted to the gaseous state with an increase in temperature. Both chemical and physical blowing agents are therefore capable of creating foam structures in polymers.

The expandable material is preferably foamed thermally, chemical blowing agents being used. Examples of suitable chemical blowing agents are azodicarbonamides, sulfohydrazides, hydrogencarbonates or carbonates.

Suitable blowing agents are, for example, also commercially available under the trade name Expancel® from Akzo Nobel, the Netherlands, or under the trade name Celogen® from Chemtura Corp., USA.

The heat required for the foaming may be introduced by external or by internal heat sources, such as an exothermic chemical reaction. The foamable material is preferably foamable at a temperature ≤250° C., in particular from 100° C. to 250° C., preferably from 120° C. to 240° C., preferably from 130° C. to 230° C.

Suitable expandable materials are, for example, one-component epoxy resin systems which do not flow at room temperature and in particular have elevated impact strength and contain thixotropic agents such as aerosils or nanoclays. For example, epoxy resin systems of this type contain 20 to 50 wt % of a liquid epoxy resin, 0 to 30 wt % of a solid epoxy resin, 5 to 30 wt % of impact modifiers, 1 to 5 wt % of physical or chemical blowing agents, 10 to 40 wt % of fillers, 1 to 10 wt % of thixotropic agents and 2 to 10 wt % of thermally activatable curing agents. Suitable impact modifiers are reactive liquid rubbers based on nitrile rubber or derivatives of polyether polyol polyurethanes, core-shell polymers and similar systems known to a person skilled in the art.

Likewise suitable expandable materials are one-component polyurethane compositions containing blowing agents and based on crystalline polyesters which have OH groups and have been mixed with further polyols, preferably polyether polyols, and polyisocyanates with blocked isocyanate groups. The melting point of the crystalline polyester should be ≥50° C. The isocyanate groups of the polyisocyanate may be blocked, for example, by nucleophiles such as caprolactam, phenols or benzoxalones. Also suitable are blocked polyisocyanates as used, for example, in powder-coating technology, which are commercially available, for example, under the trade names Vestagon® BF 1350 and Vestagon® BF 1540 from Degussa GmbH, Germany. So-called encapsulated or surface-deactivated polyisocyanates, which are known to a person skilled in the art and are described for example in EP 0 204 970, are likewise suitable isocyanates.

Also suitable as expandable materials are two-component epoxy/polyurethane compositions which contain blowing agents, as described, for example, in WO 2005/080524 A1.

Also suitable as expandable materials are ethylene-vinyl acetate compositions containing blowing agents.

Expandable materials that are also suitable are sold by Sika Corp., USA, for example under the trade name SikaBaffle® 240, SikaBaffle® 250 or SikaBaffle® 255, and are described in patents U.S. Pat. Nos. 5,266,133 and 5,373,027. Such expandable materials are particularly preferred for the present invention.

Preferred expandable materials with reinforcing properties are for example those sold by Sika Corp., USA under the trade name SikaReinforcer® 941. These are described in U.S. Pat. No. 6,387,470.

In one exemplary embodiment, the expandable material has an expansion ratio of from 800% to 5000%, preferably from 1000% to 4000%, more preferably from 1500% to 3000%.

Expandable materials having such expansion ratios offer the advantage that it is possible thereby to achieve reliable sealing and/or insulation of the structural element with respect to liquids and sound.

In one exemplary embodiment, the expandable material is in the form of a thermally induced material.

This has the advantage that the oven for baking the dip coating liquid may thereby be used to expand the expandable material and therefore to insulate the cavity. Consequently, no additional working step is required.

In one exemplary embodiment, the expandable material is produced from two different materials during the extrusion.

In one exemplary development, the two expandable materials differ particularly in respect of an expansion ratio and/or a temperature range for the expansion.

The carrier may consist of any desired materials. Preferred materials are plastics, in particular polyurethanes, polyamides, polyesters and polyolefins, preferably high temperature-resistant polymers such as poly(phenylene ether), polysulfones or polyether sulfones; or any desired combinations of these materials. Polyamides, in particular polyamide 6, polyamide 6,6, polyamide 11, polyamide 12, or a mixture thereof, are particularly preferably used.

In one exemplary embodiment, the carrier is produced fully or partially from Plexiglas (polymethyl methacrylate, abbreviated to PMMA) during the extrusion.

In one exemplary embodiment, the carrier is produced fully or partially from polyamide 6, or polyamide 6,6, or polyamide 6.10, or polyamide 11, or polyamide 12, or a mixture thereof, during the extrusion.

In one exemplary embodiment, the carrier is produced fully or partially from nylon 10 during the extrusion.

Details and advantages of the invention will be described below with the aid of exemplary embodiments and with reference to schematic drawings. In the drawings:

FIG. 1 shows an exemplary representation of a vehicle body;

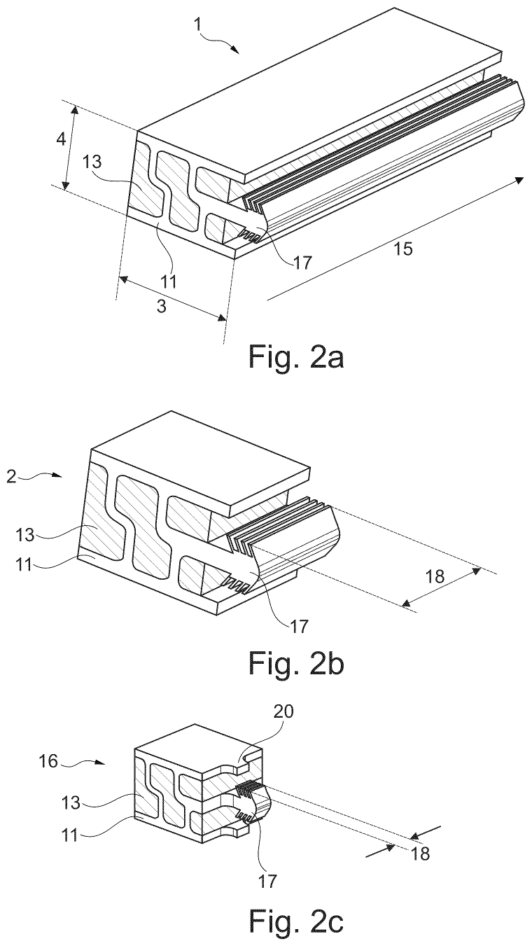

FIGS. 2a to 2c show an exemplary representation of a method for producing an insulating element; and

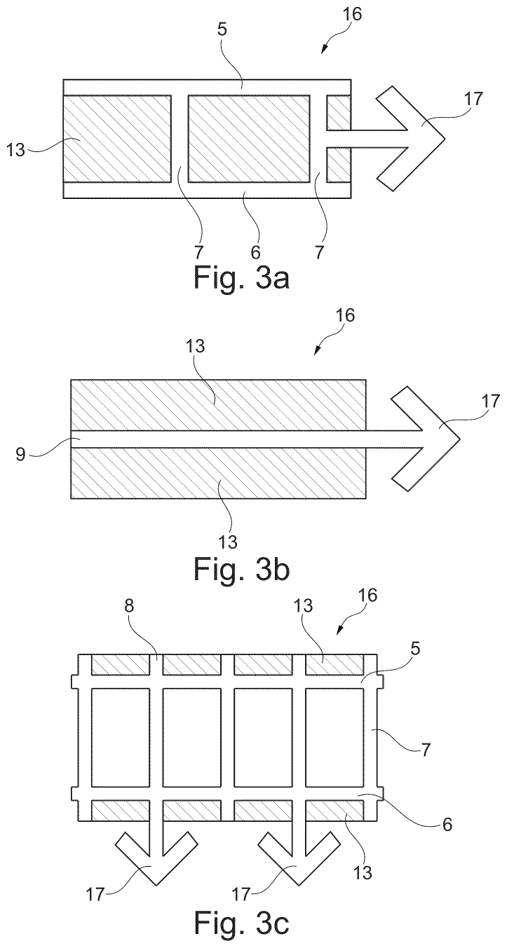

FIGS. 3a to 6 show a schematic representation of exemplary cross sections of the extrudates.

FIGS. 2a to 2c represent a method for producing an insulating element 16 by way of example and schematically. FIG. 2a shows the extrudate 1, FIG. 2b shows a trimmed extrudate 2 and FIG. 2c lastly shows the finished insulating element 16.

The extrusion direction 15 is indicated in FIG. 2a. A cross section of the extrudate 1 perpendicularly to the extrusion direction 15 has a rectangular basic shape with a height 4 and a width 3. A largest width 3 of the extrudate 1 is at most 20% more than a smallest width 3 of the extrudate 1. Furthermore, a largest height 4 of the extrudate 1 is likewise at most 20% more than a smallest height 4 of the extrudate 1.

In this exemplary embodiment, the carrier 11 comprises two walls extending parallel and ribs extending between the walls.

In this exemplary embodiment, the extrudate 1 is cut substantially perpendicularly to the extrusion direction 15 during the trimming. The resulting trimmed extrudates 2 are then processed further by removing constituents of the trimmed extrudate 2. In this exemplary embodiment, only constituents of the carrier 11 are removed. The carrier 11 is in this case removed in the region of the walls extending parallel and in the region of the extruded clip 17 to such an extent that a clip 17 having a depth 18 of less than 1 cm is created and that spacer elements 20, which are helpful when positioning the insulating element in the structural element, are formed by the walls.

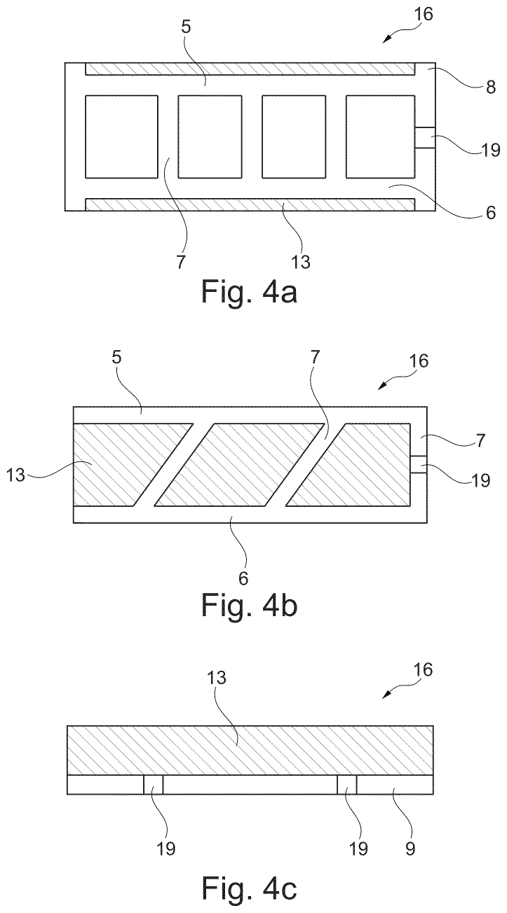

FIGS. 3a to 4c represent various exemplary embodiments of cross sections of an extrudate, or of an insulating element 16. FIGS. 3a to 3c respectively show insulating elements 16 in which the clips 17 are formed integrally with the carrier 11, and FIGS. 4a to 4c show various examples of insulating elements 16 in which the clip is configured as a separate part, which is then arranged in an opening 19 of the carrier 11.

The insulating element 16 according to FIG. 3a has a first wall 5 and a second wall 6 of the carrier 11, which are connected to one another by two ribs 7. Expandable material 13 is arranged between the first wall 5 and the second wall 6.

FIG. 3b represents a further exemplary insulating element 16. In this exemplary embodiment, the carrier is extruded as a plate 9, expandable material 13 being extruded on both sides of the plate 9.

FIG. 3c represents a further example of an insulating element. The carrier 11 again comprises a first wall 5 and a second wall 6, a plurality of ribs 7 connecting the two walls 5, 6 to one another in this example. In this exemplary embodiment, the expandable material 13 is arranged on outer sides of the walls 5, 6. Protective walls 8 are respectively arranged next to the expandable material 13 in order to avoid damaging the expandable material during transport and handling of the insulating elements 16. In this exemplary embodiment, the intermediate space between the first wall 5 and the second wall 6 is free from expandable material 13.

FIG. 4a in turn represents an exemplary insulating element. Here, the expandable material 13 is likewise arranged on outer sides of the first wall 5 and of the second wall 6 and is protected against mechanical influences by protective walls 8. The exemplary insulating element 16 in FIG. 4b again has a first wall 5 and a second wall 6. In this exemplary embodiment, the two walls 5, 6 are connected to one another by three ribs 7, two of these ribs being arranged obliquely with respect to a height of the cross section.

FIG. 4c lastly shows an insulating element 16 which in turn comprises a plate 9. In this exemplary embodiment, expandable material 13 is arranged only on one side of the plate 9, the other side of the plate 9 being free from expandable material.

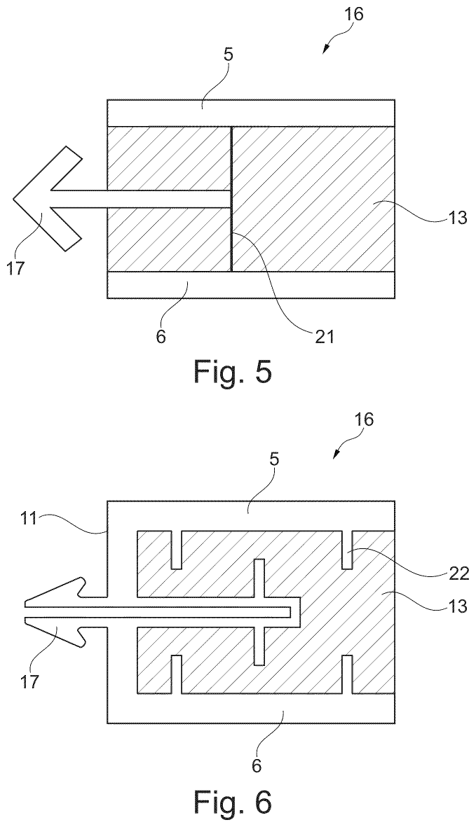

FIG. 5 shows a further exemplary insulating element 16, which has a carrier 11 with a first wall 5 and a second wall 6. Expandable material 13 is again arranged between the walls 5, 6. In this exemplary embodiment, the insulating element 16 additionally has a film 21 which connects the two walls 5, 6 to one another. The film 21 is preferably anchored in the walls 5, 6. During an expansion of the expandable material 13, the film 21 can prevent the two walls 5, 6 from being pressed against one another too strongly by the expanding 5 material, or the insulating element 16 from deforming.

FIG. 6 shows a further exemplary insulating element 16. In this exemplary embodiment, the carrier 11 likewise has an upper wall 5 and a lower wall 6, and expandable material 13 arranged between the walls 5, 6. The insulating element 16 additionally has a plurality of projections 22, which are arranged on the carrier 11 and protrude into the expandable material 13. These projections 22 make it possible to prevent delamination of the expandable material 13 during and/or after an expansion, by the binding of the expanding or expanded material 13 to the carrier 11 being improved.

### LIST OF REFERENCE SIGNS

1 extrudate
2 trimmed extrudate
3 width
4 height
5 first wall
6 second wall
7 rib
8 protective wall
9 plate
10 vehicle body
11 carrier
12 structural element
13 expandable element
14 structural element
15 extrusion direction
16 insulating element
17 clip
18 depth
19 opening
20 spacer element
21 film
22 projection

1. A method for producing an insulating element for insulating a structural element in a motor vehicle, the method comprising the steps of:
extruding a carrier and an expandable material in an extrusion direction, wherein a cross section of the extrudate having a substantially rectangular basic shape perpendicularly to the extrusion direction , wherein a largest width of the extrudate being at most 20% more than a smallest width of the extrudate, and wherein a largest height of the extrudate being at most 20% more than a smallest height of the extrudate;
trimming the extrudate; and
removing constituents of the carrier and/or of the expandable material from the trimmed extrudates in order to form individual insulating elements.

2. The method as claimed in claim 1, wherein the extrudate is cut substantially perpendicularly to the extrusion direction during the trimming.

3. The method as claimed in claim 1, wherein the carrier is extruded with a first wall and a second wall, which extend substantially parallel to one another and are connected to one another by at least one rib.

4. The method as claimed in claim 3, wherein the expandable material is extruded between the two walls.

5. The method as claimed in claim 3, wherein the expandable material is extruded onto outer sides of the walls, a region between the walls remaining free from expandable material.

6. The method as claimed in claim 5, wherein the carrier is furthermore extruded with protective walls, which are arranged on the outer side of the two walls and next to the expandable material.

7. The method as claimed in claim 5, wherein the expandable material has an expansion ratio of from 300 to 1200%.

8. The method as claimed in claim 5, wherein a plurality of ribs are extruded between the walls in order to form a mechanically load-bearing carrier.

9. The method as claimed in claim 1, wherein the carrier is extruded as a plate, and wherein the expandable material is extruded on one or both sides of the plate.

10. The method as claimed in claim 1, wherein at least one clip, which protrudes beyond the rectangular basic shape of the cross section of the extrudate, is extruded integrally with the carrier.

11. The method as claimed in claim 10, wherein a depth of the clip is reduced in the extrusion direction during the removal to such an extent that one or more clips having a depth of less than 1 cm are thereby formed.

12. The method as claimed in claim 1, wherein the method comprises the additional steps:
forming at least one opening in the extruded carrier; and
introducing a prefabricated clip into the opening.

13. The method as claimed in claim 12, wherein the prefabricated clip is formed from a different material than the extruded carrier.

14. The method as claimed in claim 1, wherein a rectangular basic outline of the trimmed extrudates, which lies in a plane of the extrusion direction and of the width of the extrudate, is modified into a non-rectangular shape during the removal.

15. The method as claimed in claim 1, wherein a width of the cross section of the extrudate is reduced during the removal.
